(19) United States
(12) Patent Application Publication
(10) Pub. No.: US 2007/0048612 A1
(43) Pub. Date: Mar. 1, 2007

(54) Alloy for negative electrode of lithium secondary battery

(75) Inventors: Kenichiro Nakajima, Tokyo (JP); Masataka Takeuchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 11/497,275

(22) Filed: Aug. 2, 2006

Related U.S. Application Data
(60) Provisional application No. 60/705,553, filed on Aug. 5, 2005.

(30) Foreign Application Priority Data
Aug. 8, 2005 (JP) 2005-223759

(51) Int. Cl. H01M 4/40; C22C 28/00

(52) U.S. Cl. 429/231.95; 252/182.1; 420/578

(57) ABSTRACT

At least two metallic materials containing element such as silicon and tin, which has ability of insertion and desertion of lithium element, and optionally another metallic material containing element such as copper are molten to prepare a melt. The melt is rapidly cooled by strip-cast method at a cooling rate of more than 2×10³ ° C./sec and no more than 10⁴ ° C./sec to be cast. Further, the cast is milled and classified into alloy powder having an average particle size of 0.1 μm to 50 μm. The alloy powder and conductive agent are laminated with binder onto a collector to obtain a negative electrode for a secondary battery. The negative electrode is employed to obtain a lithium secondary battery having high electric charge and discharge capacity, and good property of charge and discharge cycle.

### TECHNICAL FIELD

The invention relates to an alloy for a negative electrode of lithium secondary battery, a method of manufacturing lithium insertable alloy, and a lithium secondary battery employing the same, which has large electric charge and discharge capacity, and has good property of charge and discharge cycle.

### BACKGROUND ART

A lithium secondary battery is plentifully used as high energy density battery for mobile electronic device and the like. Development of multifunction faster than that of the power saving increases a consumed power to be difficult to lengthen the operation time, though development of a power saving electronic element is being carried out to lengthen an operation time of the mobile electronic device.

The secondary battery requires high electric capacity and downsizing in order to satisfy both of long operation time and multifunction in the mobile electronic device.

Carbon material is usually employed for the material for negative electrode in the lithium secondary battery. The carbon material cannot theoretically have lithium element inserted more than ratio of LiC₆, the theoretical capacity is 372 mAh/g. Use of material other than carbon (hereafter, non-carbon material) such as alloy having high theoretical capacity is being researched as material for the negative electrode in the lithium secondary battery.

Concretely, the element, such as Si, Al, Sn, Ge, and Sb, having a theoretical high capacity is being researched.

Particularly Si element reaches 4200 mAh/g in a theoretical capacity, exceeds 3900 mAh/g of lithium metal in an expected capacity, and maybe favorable for downsizing and high capacity of the battery.

However these non-carbon material expand and contract large by a change in the structure at the time of insertion and desertion of lithium ion. Lithium ion is inserted gradually from surface to inside of the non-carbon material, so the material is broken and gone into bits by the difference of volume change between the surface and inside. The bits divide an electric contact between the non-carbon materials, increasing an internal resistance.

Patent document 1 discloses a material for a negative electrode having structure mainly comprising a Li insertion phase α (ex. coexistence of Si phase and Sn phase), and a phase β consisting of inter-metallic compound or solid solution.

In the document is described a material melt selecting composition so as to deposit an initial crystal β at the time of casting before a eutectic crystal of α and β is rapidly cooled and cast by a atomization method, a roll rapid cooling method and the like, which composes an microstructure having a layer of α and β interposed between round and/or pillar initial crystals of β, or a heat-treated microstructure thereof to obtain the material for negative electrode. An alloy concretely shown as producing example is 20 μm in a thickness, a few nano-meters in size of alloy microstructure.
[patent document 1] JP-A-2001-297757

Patent document 2 discloses a negative electrode comprising an alloy having grid unit which comprises multiple layer structure having a layer containing Sn element as constituent and a layer containing MA, in which MA is at least one element selected from the group consisting of La, Ce, Pr, Nd, Mg, Si, Ca, Ga, Y, Zr, Nb, Ag, In, Hf and Pb, as constituent. In the document 2 is described that the alloy can be produced by a strip cast method at a cooling rate of no less than 100° C./sec and no more than 2000° C./sec, preferably no less than 300° C./sec and no more than 1300° C./sec. The resultant alloy has a thickness of no less than 10 μm and no more than 50 μm.
[patent document 2] JP-A-2006-120324

Patent document 3 suggests a material for a negative electrode characterized in that a mixture of particle comprising a compound which contains silicon atom or/and tin atom having ability of insertion and desertion of lithium ion and vapor grown carbon fiber is comprised. The material for a negative electrode has an attempt to relieve a volume expansion of the particle by compounding together a fibrous carbon.
[patent document 3] JP7A-2004-178922

Patent document 4 describes an active material for a battery, which has alkaline metal or alkaline earth metal inserted and deserted, comprising a solid solution which is formed in non-equilibrium state of element A which can be alloyed with alkaline metal or alkaline earth metal and element B which cannot alloyed with alkaline metal or alkaline earth metal.
[patent document 4] JP-A-2002-75350

Patent document 5 discloses a material for a negative electrode comprising an Si alloy powder containing Si element and any one or no less than 2 elements of Cu, Ni, and Co, as constituent. In the document 5 is described the Si alloy powder which is made by a single roll method or an atomization method comprising a eutectic crystal phase comprising an inter-metallic compound phase containing Si element and at least one element of Cu, Ni, and Co as constituent and a Si phase, and an initial crystal phase of Si dispersed in the eutectic crystal phase.

[patent document 5] JP-A-2004-362895

### DISCLOSURE OF THE INVENTION

Subject to be Solved by the Invention

According to the review of the inventors, the non-carbon materials described in the above patent documents 1 to 5 are not enough satisfied in the cyclic property, because the materials are broken and gone into bits by the volume change.

An object of the invention is to provide an alloy for a negative electrode of lithium secondary battery, a method of manufacturing lithium insertable alloy, and a lithium secondary battery, which has large electric charge and discharge capacity, and has good property of charge and discharge cycle.

Means for Solving the Subject

The inventors reviewed a method of manufacturing an alloy comprising element having ability of insertion and desertion of lithium element in order to achieve the object. As a result, the inventors found out that an alloy comprising a phase A containing an element which has an ability of insertion and desertion of lithium element as main constituent, and a phase B containing another element which has an ability of insertion and desertion of lithium element as main constituent, in which the phase A larger in the phases has a specific size, is employed as a material for a negative electrode in a lithium secondary battery, which causes little volume change and hardly falling into pieces to obtain a lithium secondary battery having large electric charge and discharge capacity and good property of charge and discharge cycle. The invention is made of further every research on the found out knowledge.

The invention specifically comprises the following modes.

(1) An alloy for a negative electrode of lithium secondary battery comprising:
a phase A containing an element which has an ability of insertion and desertion of lithium element as main constituent, and
a phase B containing another element which has an ability of insertion and desertion of lithium element as main constituent,
in which the phase A larger in the phases has a size of 0.5 μm to 20 μm.

(2) The alloy for a negative electrode of lithium secondary battery according to (1), in which any one of the phase A and the phase B is a dispersed phase, and another is a continuous phase.

(3) The alloy for a negative electrode of lithium secondary battery according to (1) or (2), in which a ratio by mass of the element as main constituent of phase A/the element as main constituent of phase B is 20/80 to 80/20.

(4) The alloy for a negative electrode of lithium secondary battery according to any one of (1) to (3), in which the element as main constituent of phase A and the element as main constituent of phase B are an element selected from the group consisting of Sn, Si, Ge, Pb, Al and In.

(5) An alloy for a negative electrode of lithium secondary battery comprising
a phase containing Si element as main constituent, and
a phase containing Sn element as main constituent,
in which the phase A larger in the phases has a size of 0.05 μm to 20 μm.

(6) The alloy for a negative electrode of lithium secondary battery according to (5), in which any one of the phase containing Si element as main constituent and the phase containing Sn element as main constituent is a dispersed phase, and another is a continuous phase.

(7) The alloy for a negative electrode of lithium secondary battery according to (5) or (6), in which a ratio by mass of Si element/Sn element is 20/80 to 80/20.

(8) The alloy for a negative electrode of lithium secondary battery according to any one of (4) to (7), further comprising at least one element selected from the group consisting of Ti, V, Co, Ni, Cu, Mo, Ru, Rh, Pd, Pt, Be, Nd, W, Au, Ag, and Ga.

(9) The alloy for a negative electrode of lithium secondary battery according to any one of (4) to (8), further comprising at least one element selected from the group consisting of B, C, N, O, S, and P.

(10) The alloy for a negative electrode of lithium secondary battery according to any one of (4) to (9), in which the total amount of at least one element selected from the group consisting of Ti, V, Co, Ni, Cu. Mo, Ru, Rh, Pd, Pt, Be, Nd, W, Au, Ag, and Ga, and at least one element selected from the group consisting of B, C, N, O, S, and P is not less than 0.1% by mass and less than 35% by mass to the entirety of the alloy.

(11) The alloy for negative electrode of lithium secondary battery according to any one of (1) to (10), of which an average particle size (d50) is 0.1 μm to 50 μm.

(12) A method of manufacturing a lithium insertable alloy comprising steps of:
melting at least two metallic materials each containing an element having an ability of insertion and desertion of lithium element to prepare a melt, and
cooling the melt by strip cast method at a rate of more than 2×10³ ° C./sec and no more than 10⁴ ° C./sec to cast the melt.

(13) The method of manufacturing a lithium insertable alloy according to (12), in which the melt is spread like a strip and is touched on a cooling roll in the strip cast method.

(14) The method of manufacturing a lithium insertable alloy according to (12) or (13), in which the element having an ability of insertion and desertion of lithium is an element selected from the group consisting of Sn, Si, Ge, Pb, Al, and In.

(15) The method of manufacturing a lithium insertable alloy comprising steps of
melting a metallic material containing Sn element and a metallic material containing Si element to obtain a melt, and
cooling the melt by strip cast method at a rate of more than 2×10³ ° C./sec, and no more than 10⁴ ° C./sec to cast the melt.

(16) The method of manufacturing a lithium insertable alloy according to (14) or (15), in which the melt further contains at least one element selected from the group consisting of Ti, V, Co, Ni, Cu, Mo, Ru, Rh, Pd, Pt, Be, Nd, W, Au, Ag, and Ga.

(17) The method of manufacturing a lithium insertable alloy according to any one of (14) to (16), in which the melt further contains at least one element selected from the group consisting of B, C, N, O, S and P.

(18) The method of manufacturing a lithium insertable alloy according to any one of (14) to (17), in which the total amount of at least one element selected from the group consisting of Ti, V, Co, Ni, Cu, Mo, Ru, Rh, Pd, Pt, Be, Nd, W, Au, Ag, ard Ga; and at least one element selected from the group consisting of B, C, N, O, S and P is not less than 0.1% by mass and less than 35% by mass to the entirety of the melt.

(19) The method of manufacturing a lithium insertable alloy according to any one of (12) to (18), in which the cast obtained by the strip cast method is strip having an average thickness of more than 50 μm and not more than 300 μm.

(20) The method of manufacturing a lithium insertable alloy according to any one of (12) to (19), further comprising a step of milling and/or classifying within ranging of 0.1 to 50 μm in an average particle size (d50).

(21) A lithium secondary battery in which the alloy for a negative electrode of a lithium secondary battery according to any one of (1) to (11) is employed.

“x [symbol] and “y [symbol] in Japanese include a boundary value x and y respectively; “x [symbol] and “y [symbol] in Japanese don't include a boundary value x and y respectively. A range of “x˜y” in Japanese includes boundary value x and y.

### EFFECTS OF THE INVENTION

The alloy for a negative electrode in a lithium secondary battery in the invention changes little in volume and scarcely falls into pieces, even though lithium ion is inserted and/or deserted.

Powder of the alloy in the invention can be employed as material for a negative electrode in a lithium secondary battery to obtain lithium secondary battery having large electric charge and discharge capacity and good property of charge and discharge cycle.

### BRIEF DESCRIPTION OF DRAWINGS

FIG. 1 cross section of an example of alloy in the invention

FIG. 2 an enlarged figure of FIG. 1

FIG. 3 a top view conceptually showing an example of equipment for single roll rapid cooling method (strip cast method)

FIG. 4 a side view of the equipment in FIG. 3

FIG. 5 a squint view of the equipment in FIG. 3

### EXPLANATION OF SYMBOL

1: crucible.

2: tundish

3: cooling roll

4: container

5: melt

C: strip cast alloy

6: roll side surface (cast surface) of strip cast alloy

9: free surface of strip cast alloy

### BEST MODE FOR CARRYING OUT THE INVENTION

[Alloy for Negative Electrode in Lithium Secondary Battery]

The alloy for a negative electrode in a lithium secondary battery in the invention comprises a phase A containing an element which has an ability of insertion and desertion of lithium element as main constituent, and a phase B containing another element which has an ability of insertion and desertion of lithium element as main constituent, in which the phase A larger in the phases has a size of 0.05 μm to 20 μm.

Sn, Si, Ge, Pb, Al, In and the like are mentioned as the element having an ability of insertion and desertion of lithium element (hereafter, “Li insertable element”). The invention is characterized in that there are at least two phases containing the Li insertable element as main constituent. For examples, there are combination of a phase containing Si element as main constituent and a phase containing Sn element as main constituent, combination of a phase containing Si element as main constituent and a phase containing Al element as main constituent, combination of a phase containing Si element as main constituent and a phase containing Ge element as main constituent, or the like. Particularly, combination of a phase containing Si element as main constituent and a phase containing Sn element as main constituent is favorable. That is, a favorable alloy for a negative electrode in a lithium secondary battery comprises a phase containing Si element as main constituent, and a phase containing Sn element as main constituent, in which the phase A larger in the phases has a size of 0.05 μm to 20 μm.

A Li-insertion by the element having ability of insertion and desertion of lithium element results going into a compound represented by the chemical formula: LiMₓ, in which M is the Li insertable element. The x is number depended on an insertion quantity of Li. When the Li insertable element has Li inserted at the maximum, x is preferably more than 0.01 and less than 6, more preferably 0.9 to 4.1, particularly preferably 0.24 to 0.51.

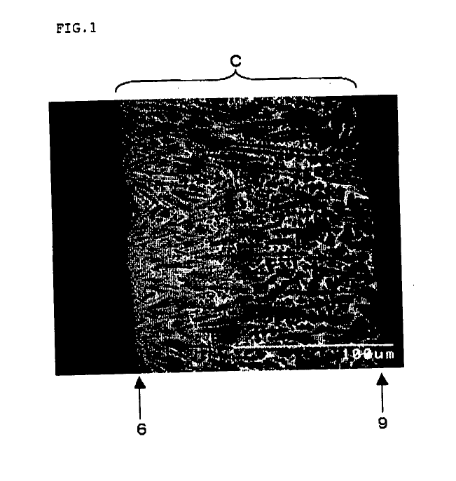

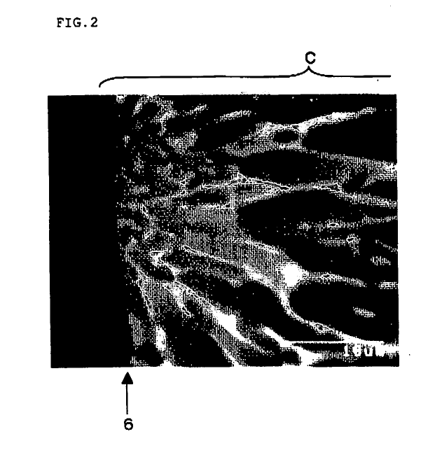

The alloy for a negative electrode in a lithium secondary battery in which any one of the phase A or the phase B is a dispersed phase, and another is a continuous phase is favorable. FIG. 1 and FIG. 2 show a example of an electronic microscopic picture of a strip cast alloy in the invention comprising a phase A containing Si element as main constituent, and a phase B containing Sn element as main constituent. Center part in FIG. 1 and right half part in FIG. 2 are a figure of strip cast alloy C. White domain is phase B, and gray domain is phase A. In FIG. 1 and FIG. 2, left edge of the strip cast alloy C is cast surface 6 which is formed by touching melt on the cooling roll. And in FIG. 1, right edge of the strip cast alloy C is free surface 9 which is the counter side of the roll-touched surface 6.

The alloy for a negative electrode in a lithium secondary battery in the invention, as shown in FIG. 1 and FIG. 2, has a microstructure that the phase B (white domain) lies mesh-like, arborescently or marble-like around the phase A (gray domain) and is smaller in a size than phase A.

Phase A having the larger size in the phases has size of 0.05 μm to 20 μm, preferably 0.2 μm to 8 μ, more preferably 0.5 μm to 8 μm, particularly preferably 0.8 μm to 2 μm. This size range of phase A allows obtaining a lithium secondary battery having stable charge and discharge property.

In an electronic microscopic picture of strip cast alloy as shown in FIG. 1, intersections of segment of line, which is drawn on a parallel to the surface of the strip cast alloy at each position corresponding to ¼, ½ and ¾ of thickness of the strip cast alloy, and phase B having smaller size are counted, length of the segment is divided by number of the intersections to obtain a quotient, and the quotients corresponding to ¼, ½ and ¾ of thickness of the strip cast alloy are averaged into a size of phase A.

Phase A, as shown in FIG. 1 and FIG. 2, has a lot of grey domains long on thickness direction and short on a parallel to the roll side surface, Phase A is preferably 0.05 to 20 μm in a minor axis, preferably 0.05 to 300 μm in a major axis. A ratio of major axis/minor axis is not particularly limited, preferably 1 to 6000, more preferably 1 to 30. A minor axis of phase B is usually shorter than that of phase A.

A ratio by mass of the element as main constituent of phase A/the element as main constituent of phase B is preferably 20/80 to 80/20, more preferably 30/70 to 70/30.

The alloy for a negative electrode in a lithium secondary battery in the invention may further comprise element other than the element having an ability of insertion and desertion of lithium element. As other element are mentioned Ti, V, Co, Ni, Cu, Mo, Ru, Rh, Pd, Pt, Be, Nd, W, Au, Ag, Ga and the like, These element may be comprised alone or in combination with at least two. It is considered that the element works in uniting phase A and phase B.

An element unavoidably entered in method of manufacturing an alloy may be comprised in the alloy for a negative electrode in a lithium secondary battery in the invention. For example, B, C, N, O, S, P, Al and the like are mentioned. When Al is used as Li insertable element, Al element is not considered to be the unavoidable element. When Al is not used as Li insertable element, Al element is considered to be the unavoidable element.

In the alloy for negative electrode of lithium secondary battery in the invention, the total amount of the element other than the element having an ability of insertion and desertion of lithium element, that is at least one element selected from the group consisting of Ti, V, Co, Ni, Cu, Mo, Ru, Rh, Pd, Pt, Be, Nd, W, Au, Ag, and Ga, and at least one element selected from the group consisting of B, C, N, O, S, and P, is preferably no less than 0.1% by mass and less than 35% by mass, more preferably no less than 0.1% by mass and no more than 10% by mass, particularly preferably no less than 0.5% by mass and no more than 5% by mass to the entirety of the alloy.

The alloy for negative electrode of lithium secondary battery in the invention is preferably within the range of 0.1 μm to 50 μm, more preferably within the range of 1 μm to 10 μm in an average particle size (d50) for suitable size of contacting surface area with lithium ion and for easily forming negative electrode. Average particle size (d50) is a particle diameter at 50% of cumulative distribution on volume, and d50 can be determined with laser diffraction particle diameter distribution meter.

A method of manufacturing alloy for negative electrode of lithium secondary battery in the invention is not particularly limited if the manufacturing method can produce the above microstructure. As conventional method of manufacturing alloy are mentioned strip cast method with single roll, making method of ribbon by super-rapid cooling method, centrifuge casting method by touching drops of melt on mold, rotating electrode method, water atomization method, gas atomization method and the like. According to the past review of the inventors, there can be found that an alloy for negative electrode of lithium secondary battery having the microstructure stipulated by the claims can be obtained by the following manufacturing method.

[Method of Manufacturing Lithium Insertable Alloy]

A method of manufacturing a lithium insertable alloy (an alloy for negative electrode of lithium secondary battery) in the invention comprises steps of melting at least two metallic materials each containing an element having an ability of insertion and desertion of lithium element to prepare a melt, and cooling the melt by strip cast method at a rate of more than 2×10³ ° C./sec and no more than 10⁴ ° C./sec to cast the melt.

(Melt Preparation Step)

The step of preparing melt is a step that material for alloy, that is the material comprising the above lithium insertable element such as an element selected from the group consisting of Sn, Si, Ge, Pb, Al and In, preferably comprising at least two metallic materials containing Si element and Sn element, is melted to prepare a melt.

In the melt which at least two metallic materials containing lithium insertable element are melted, an element other than lithium insertable element such as at least one element selected from the group consisting of Ti, V, Co, Ni, Cu, Mo, Ru, Rh, Pd, Pt, Be, Nd, W, Au, Ag, and Ga, or at least one element selected from the group consisting of B, C, N, O, S, and P may be further molten.

The metallic materials may be molten together after pre-mixing. Or one metallic material may be added into molten other metallic material to melt all of the metallic materials.

A part of the lithium insertable elements is not particularly limited, a ratio by mass of the element as main constituent of phase A/the element as main constituent of phase B is preferably 20/80 to 80/20, more preferably 30/70 to 70/30.

The part of elements other than the lithium insertable elements is preferably no less than 0.1% by mass and less than 35% by mass, more preferably no less than 0.1% by mass and no more than 10% by mass, particularly preferably no less than 0.5% by mass and no more than 5% by mass to the entirety of the alloy.

Melting of the metallic materials is carried out by heating at temperature of melting point or more. Heating temperature is usually 1200° C. to 1800° C. It is preferable that melting is carried out in atmosphere of inert gas of 0.1 MPa (ambient pressure) to 0.2 MPa in pressure or in vacuum. As the inert gas are mentioned Ar, He and the like.

Impurities such as metallic oxide in the metallic material are deoxidized by heating to increase a fineness of the alloy. And so a heating temperature is so low that the deoxidization reaction is not enough proceeded, which decreases a fineness of alloy. A heating temperature is so high that nuch metallic element is evaporated, hardly regulating the desired chemical contents.

(Casting Step)

The casting step is a step that the melt obtained by the above step of preparing melt is rapidly cooled and cast to make alloy. As conventional rapid cooling and casting method are mentioned strip cast method, new centrifuge cast method with tundish comprising rotated disc, centrifuge cast method and so on. In the manufacturing method in the invention, strip cast method is used.

In the invention, a cooling rate in the casting step is more than 2×10³ ° C./sec and no more than 10⁴ ° C./sec, preferably 3×10³ ° C./sec to 10⁴ ° C./sec, more preferably 3×10³ ° C./sec to 8×10³ ° C./sec, at least in the range from temperature of the melt to 600° C.

This regulation of the cooling rate can control a size of phase A. The cooling rate is so slow that a size of phase A is larger than 20 μm. The cooling rate is so fast that a size of phase A is smaller than 0.05 μm.

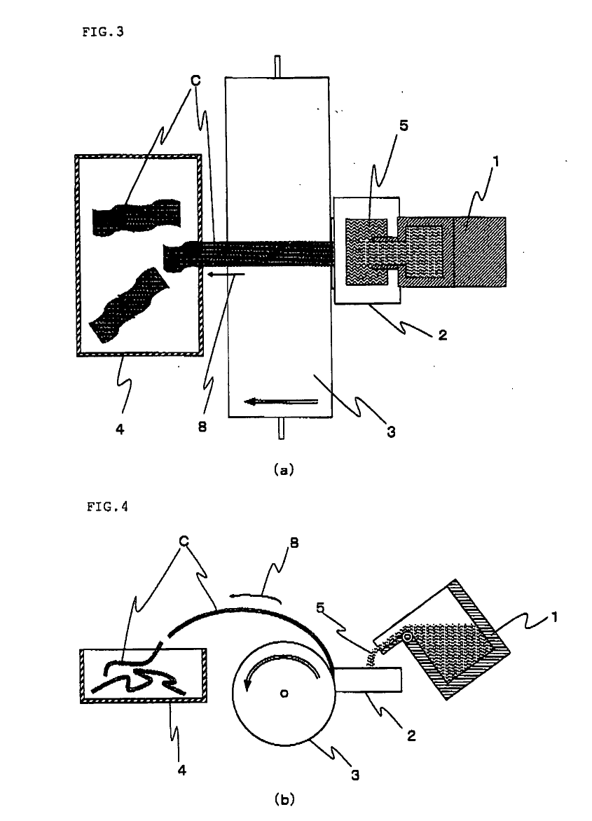

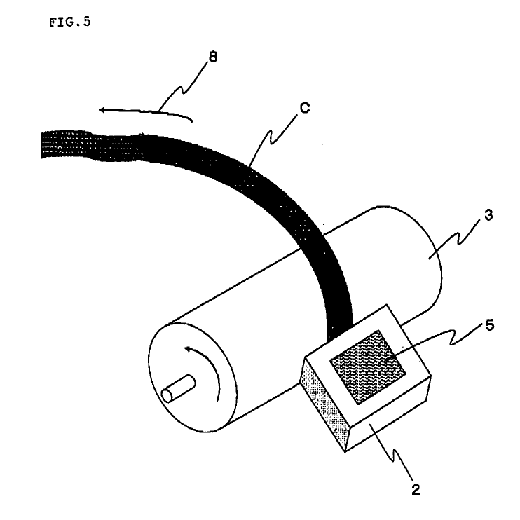

FIG. 3 to 5 are figures for explanation of strip cast method. FIG. 3 is a top view conceptually showing an example of equipment for strip cast method, FIG. 4 is a side view of the equipment in FIG. 3, and FIG. 5 is a squint view of the equipment in FIG. 3.

The equipment as shown in the figures comprises a crucible 1, tundish 2, a cooling roll 3, and a container 4. Material for alloy is melted in a crucible 1 to obtain melt 5 in the equipment.

The resultant melt 5 is poured onto a cooling roll 3 which rotates in the set direction (anticlockwise in the figures) through a tundish 2.

The tundish 2 is a unit furnished rectifier or slag remover.

The cooling roll 3 is a roll cooled with water and so on. The melt 5 touched on the roll is rapidly cooled and cast into alloy. A cooling rate of the melt 5 can be controlled by peripheral velocity of the cooling roll, pouring rate of the melt on the cooling roll, and so on. The cooling roll usually comprises readily available material having high thermal conductivity such as copper, or copper alloy. Depending on the material or surface condition of the cooling roll, metal may be easily adhered on the roll surface, and so cleaning unit may be optionally placed.

As shown in FIG. 3 or FIG. 5, It is preferable that the melt spread like a strip is poured from slit (rectifier) of the tundish 2 and touched on the cooling roll. Spreading like a strip and touching of the melt can readily provide strip cast alloy C.

The resultant alloy is peeled off the cooling roll by centrifuge force, and jumps in a direction as arrow 8 into strip cast alloy C, and the strip cast alloy C is collected in container 4. In the invention, thickness of the strip cast alloy C (cast) is adjusted to preferably more than 50 μm and no more than 300 μm, more preferably no less than 80 μm and no more than 210 μm. by controlling a pouring rate onto the cooling roll and so on. Thickness of the strip cast alloy is so thin that casting rate excessively increases, and a size of phase A is too small. Thickness of the strip cast alloy is so thick that casting rate decreases, and a size of phase A is too large.

The collected strip cast alloy C is cooled to room temperature in the container 4 and is taken out. A cooling mechanics, a heat insulating mechanics and so on had better be installed in the container to control a cooling rate of a strip cast alloy C in the container.

This control of a cooling rate to room temperature after cooling into 600° C. by the cooling roll can further improve an uniformity of alloy structure.

(MILLING and/or CLASSIFYING STEP)

A particle size of the lithium insertable alloy obtained by the above steps may be adjusted to use the alloy as a material for a negative electrode of a lithium secondary battery. Adjustment of a particle size, is no: limited by the manner, may be carried out by the conventional milling method and/or classifying method. As the manner for milling are mentioned hummer mill, jaw crusher, collision type crusher, ball mill, attriter, jet mill and so on. In the manner for milling, jet mill is favorable because that roughly crushed alloy itself can be collided by high pressure nitrogen or argon gas to be milled finely, which can provide contamination free and high-grade fine powder. A jet mill can further provide a fine powder having a little oxide on the surface thereof by sealing off a collection unit for powder.

Addition of a carbon material such as graphite powder and carbon fiber at the time of milling an alloy can give a composite of alloy and carbon. The composite is favorable to a material for negative electrode.

As the manner for classifying are mentioned an airflow classification and a sieve classification.

The alloy powder oxidizes or likely burns while it is left in air. So the alloy powder is preferably immersed in ethylene carbonate, propylene carbonate and the like to be safely kept.

[Lithium Secondary Battery]

The lithium secondary battery in the invention is that the above alloy for a negative electrode of lithium secondary battery is employed. Specifically, the lithium secondary battery is that the above-mentioned lithium insertable alloy powder is employed in an active material for negative electrode of lithium secondary battery. The lithium insertable alloy powder, as described in the above, is preferably within the range of 0.1 μm to 50 μm, more preferably within the range of 1 μm to 10 μm, particularly preferably within the range of 1 μm to 5 μm in an average particle size (d50).

The negative electrode of a lithium secondary battery can be obtained by laminating active material and conductive material with binder on a collector.

As the binder are mentioned polyvinylidenefluoride, polytetrafluoroethylene, styrene-butadiene rubber and so on. A solution or a dispersion of the binder with solvent such as N-methylpyrrolidone, xylene, and water is suitable for mixing with active material and so on.

A carbon based conductive agent is usually used as the conductive material. The collector is foil, punching metal, net or the like made from a conventional material such as copper, aluminum, stainless steel, nickel, and alloy thereof. A surface roughened collector by etching may be used.

The active material and the conductive material may be laminated on the collector by conventional method. As the lamination method, for example, there is a method which comprises kneading the above lithium insertable alloy, conductive material and binder to prepare a slurry for application, applying the slurry on the collector, drying and pressing the paint film.

As the manner for kneading of the alloy, conductive material and binder can be mentioned ribbon mixer, screw type kneader, planetary mixer, universal mixer and so on.

As the manner for applying the slurry on the collector can be mentioned doctor blade, bar coater and the like. In the press operation after the application are usually used roll press and so on.

A lithium secondary battery can be obtained by facing the above negative electrode and positive electrode each other in the state that separator is interposed between the electrodes, putting them into electrolyte in a vessel, and sealing off the vessel.

The positive electrode, separator, and electrolyte used in the lithium secondary battery in the invention may be usually those used in conventional lithium secondary battery. As the positive electrode is mentioned a electrode made from lithium cobaltate, lithium nickelate, lithium manganate and complex oxide or mixture thereof and the like. As the separator are mentioned micro-porous film and non-woven fabric made from polyethylene or polypropylene.

As the electrolyte is mentioned known lithium salt such as LiPF₆, LiBF₄, and lithium imide salt. The electrolyte is usually used after being dissolved in solvent. As the solvent for dissolving the electrolyte is mentioned known solvent such as diethyl carbonate, ethylene carbonate, and propylene carbonate. Concentration of electrolyte solution is not particularly limited, is usually round 1 mol/l.

The following example and comparative example are shown to explain the invention in the concrete. The invention is not limited by these examples.

### EXAMPLE

Into a crucible comprising double layer structure of carbon and alumina were put 210 g of tin metal (2N {purity of 99%}), 455 g of silicon metal (4N {purity of 99.99%}), and 35 g of electrolytic copper, and were heated at 1400° C. in the presence of argon in a high frequency induction furnace to prepare melt. With an apparatus for strip cast method comprising units as shown in FIG. 3 to FIG. 5, the melt was rectified, spread like a strip, and touched on a cooling roll for rapidly cooling to be cast into a strip cast alloy. The cooling roll made from copper rotated at 1.0 m/sec in peripheral velocity, thickness of the strip cast alloy was 300 μm, and a cooling rate from melt temperature to 600° C. was 3000° C./sec.

The obtained strip cast alloy was crushed in an alumina mortar into powder to be analyzed with X-ray diffraction method. The diffraction peaks corresponding to Sn metal and Si metal were respectively identified. The cross section of alloy closed up with a scanning electron microscope (S-530 produced by Hitachi High-Technologies Co.) showed two phases which were a phase mainly containing silicon element and a phase mainly containing tin element. As shown in FIG. 1 and FIG. 2, phase B mainly containing tin element (white domain) lies mesh-like, arborescently or marble-like around phase A mainly containing silicon element (gray domain). Intersections of segment of line, drawn on a parallel to the surface of the strip at each position corresponding to ¼, ½ and ¾ of thickness of the strip, and phase B were counted, length of the segment was divided by number of the intersections, and the quotients corresponding to ¼, ½ and ¾ of thickness of the strip were averaged into a size of phase A, in the cross section picture of strip cast alloy. A size of phase A was around 8 μm.

(Evaluation of Battery Property)

The above strip cast alloy was wet-pulverized in iso-propanol with an attriter into alloy powder having an average particle size of 1.3 μm.

Into 1 part by mass of the above alloy powder were added 0.2 part by mass of acetylene black (made by Denki Kagaku Kogyo K.K.), and 0.1 part by mass of polyvinylidenefluoride binder (made by KUREHA CO.) Proper quantity of N-methyl pyrrolidone was further added as solvent. These were kneaded with a planetary mixer to obtain an undiluted solution. The undiluted solution was diluted into suitable viscosity for application, which was applied on high-grade cooper foil with a doctor blade into thickness of approximately 100 μm, and was vacuum-dried to obtain a material for negative electrode.

The negative electrode material was stamped into a disc having diameter of 18 mm, was pressed between press plates made from super hard alloy, and was vacuum-dried again at 120° C. for 12 hours to obtain a negative electrode.

Lithium metal foil was stamped into a disc having diameter of 18 mm to obtain a counter electrode. Micro-porous film made from polypropylene was stamped into a disc having a diameter of 19 mm to obtain a separator.

The negative electrode, the separator, and the counter electrode were piled in this order, and were stored in a cell with screw type lid made from polypropylene. An electrolytic solusion, which 1 mol/l in concentration of LiPF₆ had been dissolved into a mixed solvent of ethylene carbonate and propylene carbonate, was poured into the cell, and the cell was sealed off with the lid to obtain a lithium secondary battery for evaluation.

(Test of Charge and Discharge Cycle Property)

Constant current charging was carried out at a current density of 0.2 mA/cm² from rest potential to 0.002 Volt, and constant voltage charging was carried out until reducing to 25 μA in current value. And then constant voltage discharging was carried out at 0.2 mA/cm² in a current density, and was cut off at 1.5 Volts. This operation as one cycle was conducted total 50 cycles.

The EXAMPLE was conducted three repetitions. Size of phase A mainly containing Si element and x value in LiMₓ in an alloy obtained by EXAMPLE; capacity after first cycle, capacity after 50th cycle, and preservation ratio of capacity after 50th cycle per capacity after first cycle of a lithium secondary battery for evaluation obtained by using the alloy are shown in TAB. 1.

### COMPARATIVE EXAMPLE

Into a crucible comprising double layer structure of carbon and alumina were put 210 g of tin metal (2N {purity of 99%}), 455 g of silicon metal (4N {purity of 99.99%}), and 35 g of electrolytic copper, which were heated at 1400° C. in the presence of argon in a high frequency induction furnace to prepare melt. The melt was poured into a book-mold made from iron having a space of 30 mm to obtain a alloy lump.

The obtained alloy lump was crushed in an alumina mortar into powder to be analyzed wish X-ray diffraction method. The diffraction peaks corresponding to Sn metal and Si metal were identified. The cross section of alloy closed up with a scanning electron microscope (S-530 produced by Hitachi High-Technologies Co.) showed two phases which were a phase mainly containing silicon element and a phase mainly containing tin element. Larger phase A was 55 μm in a size.

The alloy lump was wet-pulverized in iso-propanol with an attriter into alloy powder having an average particle size of 1.5 μm.

The COMPARATIVE EXAMPLE was conducted three repetitions. Size of phase A mainly containing Si element and x value in LiMₓ in an alloy obtained by COMPARATIVE EXAMPLE; capacity after first cycle, capacity after 50th cycle, and preservation ratio of capacity after 50th cycle per capacity after first cycle of a lithium secondary battery for evaluation obtained by using the alloy were determined by the same manner as EXAMPLE. The evaluation result are shown in TAB. 1.

As shown in TAB. 1, a fall of capacity after 50th cycle is less by using the alloy obtained in the invention (EXAMPLE) for negative electrode than by using the alloy made by the book-mold casting (COMPARATIVE EXAMPLE), by which alleviation of a fall of capacity by collapse of an alloy particle is found.

TABLE 1

| | | | | | Capacity | Capacity | Preservation |
|---|---|---|---|---|---|---|---|
| | | | Size of | | after 1st | after 50th | ratio of |
| | | | Phase A | x value | Cycle | Cycle | capacity |
| | | Process | [μm] | in LiMₓ | [mAh/g] | [mAh/g] | [%] |
| Ex. | 1 | SC method | 8 | 0.25 | 848 | 577 | 68.0 |
| | 2 | SC method | 8 | 0.25 | 857 | 602 | 70.2 |
| | 3 | SC method | 8 | 0.25 | 824 | 591 | 71.7 |
| Comp. Ex. | 1 | BM method | 55 | 0.25 | 758 | 185 | 24.4 |
| | 2 | BM method | 55 | 0.25 | 695 | 170 | 24.5 |
| | 3 | BM method | 55 | 0.25 | 744 | 112 | 15.0 |

*SC method: strip casting method BM method: Book-mold casting method

1. An alloy for a negative electrode of lithium secondary battery comprising:
a phase A containing an element which has an ability of insertion and desertion of lithium element as main constituent, and
a phase B containing another element which has an ability of insertion and desertion of lithium element as main constituent, in which the phase A larger in the phases has a size of 0.05 μm to 20 μm.

2. The alloy for a negative electrode of lithium secondary battery according to the claim 1, in which any one of the phase A and the phase B is a dispersed phase, and another is a continuous phase.

3. The alloy for a negative electrode of lithium secondary battery according to the claim 1, in which a ratio by mass of the element as main constituent of phase A/the element as main constituent of phase B is 20/80 to 80/20.

4. The alloy for a negative electrode of lithium secondary battery according to claim 1, in which the element as main constituent of phase A and the element as main constituent of phase B are an element selected from the group consisting of Sn, Si, Ge, Pb, Al and In.

5. An alloy for a negative electrode of lithium secondary battery comprising
a phase containing Si element as main constituent, and a phase containing Sn element as main constituent,
in which the phase A larger in the phases has a size of 0.05 μm to 20 μm.

6. The alloy for a negative electrode of lithium secondary battery according to claim 5, in which any one of the phase containing Si element as main constituent and the phase containing Sn element as main constituent is a dispersed phase, and another is a continuous phase.

7. The alloy for a negative electrode of lithium secondary battery according to claim 5, in which a ratio by mass of Si element/Sn element is 20/80 to 80/20.

8. The alloy for a negative electrode of lithium secondary battery according to claim 4, further comprising at least one element selected from the group consisting of Ti, V, Co, Ni, Cu, Mo, Ru, Rh, Pd, Pt, Be, Nd, W, Au, Ag, and Ga.

9. The alloy for a negative electrode of lithium secondary battery according to claim 4, further comprising at least one element selected from the group consisting of B, C, N, O, S, and P.

10. The alloy for a negative electrode of lithium secondary battery according to claim 4, in which the total amount of at least one element selected from the group consisting of Ti, V, Co, Ni, Cu, Mo, Ru, Rh, Pd, Pt, Be, Nd, W, Au, Ag, and Ga, and at least one element selected from the group consisting of B, C, N, O, S, and P is not less than 0.1% by mass and less than 35% by mass to the entirety of the alloy.

11. The alloy for negative electrode of lithium secondary battery according to claim 1, of which an average particle size (d50) is 0.1 μm to 50 μm.

12. A method of manufacturing a lithium insertable alloy comprising steps of:
melting at least two metallic materials each containing an element having an ability of insertion and desertion of lithium element to prepare a melt, and
cooling the melt by strip cast method at a rate of more than 2×10³ ° C./sec and no more than 10⁴ ° C./sec to cast the melt.

13. The method of manufacturing a lithium insertable alloy according to the claim 12, in which the melt is spread like a strip and is touched on a cooling roll in the strip cast method.

14. The method of manufacturing a lithium insertable alloy according to the claim 12, in which the element having an ability of insertion and desertion of lithium is an element selected from the group consisting of Sn, Si, Ge, Pb, Al, and In.

15. The method of manufacturing a lithium insertable alloy comprising steps of
melting a metallic material containing Sn element and a metallic material containing Si element to obtain a melt, and
cooling the melt by strip cast method at a rate of more than 2×10³ ° C./sec, and no more than 10⁴ ° C./sec to cast the melt.

16. The method of manufacturing a lithium insertable alloy according to the claim 14, in which the melt further contains at least one element selected from the group consisting of Ti, V, Co, Ni, Cu, Mo, Ru, Rh, Pd, Pt, Be, Nd, W, Au, Ag, and Ga.

17. The method of manufacturing a lithium insertable alloy according to claim 14, in which the melt further contains at least one element selected from the group consisting of B, C, N, O, S and P.

18. The method of manufacturing a lithium insertable alloy according to claim 14, in which the total amount of at least one element selected from the group consisting of Ti, V, Co, Ni, Cu, Mo, Ru, Rh, Pd, Pt, Be, Nd, W, Au, Ag, and Ga; and at least one element selected from the group consisting of B, C, N, O, S and P is not less than 0.1% by mass and less than 35% by mass to the entirety of the melt.

19. The method of manufacturing a lithium insertable alloy according to claim 12, in which the cast obtained by the strip cast method is strip having an average thickness of more than 50 μm and not more than 300 μm.

20. The method of manufacturing a lithium insertable alloy according to claim 12, further comprising a step of milling and/or classifying within ranging of 0.1 to 50 μm in an average particle size (d50).

21. A lithium secondary battery in which the alloy for a negative electrode of a lithium secondary battery according to claim 1 is employed.
